(19) United States
(12) Patent Application Publication
(10) Pub. No.: US 2010/0030638 A1
(43) Pub. Date: Feb. 4, 2010

(54) Trust Network Based Advertising System

(76) Inventors: John Stannard Davis, III, Corte Madera, CA (US); Eric Moe, Mill Valley, CA (US)

Correspondence Address: STEFAN KIRCHANSKI, VENABLE LLP 2049 CENTURY PARK EAST, 21ST FLOOR, LOS ANGELES, CA, 90067, US

(21) Appl. No.: 12/442,525

(22) PCT Filed: Sep. 24, 2007
(86) PCT No.: PCT/US07/79293

§ 371 Date: Apr. 28, 2009

Related U.S. Application Data
(60) Provisional application No. 60/826,562, filed on Sep. 22, 2006.

(51) Int. Cl. G06Q 30/00; G06Q 10/00; G06F 15/16

(52) U.S. Cl. 705/14.43; 705/14.44; 705/14.52; 705/14.73; 709/204

(57) ABSTRACT

The inventive system uses a trust network rating system to target advertisements thereby increasing the effectiveness as well as the palatability of the advertisement. A user of an online system sets up a trust network by indicating criteria whereby the user trusts other users. Ratings made by the other users of goods or services are evaluated according to the particular trust network the user has set up. The user receives advertisements only from those vendors who have met thresholds based on the evaluated ratings. This ensures that the user receives only pertinent and interesting advertisements so that the user is more likely to respond positively to the advertisements.

### CROSS-REFERENCE TO PRIOR APPLICATIONS

The present application is based on and claims the priority and benefit of U.S. Provisional Patent Application No. 60/826,562 filed 22 Sep. 2006.

### U.S. GOVERNMENT SUPPORT

Not Applicable.

### BACKGROUND OF THE INVENTION

1. Area of the Art

This application is related to the art of improving advertising and more specifically to a system of advertising which uses an online trust network to target advertisements based upon the ratings of the advertisements' content or source according to the user's trust network.

2. Description of the Background Art

The present Invention comes about from our perception of a need for a method of advertising which provides advertisement viewers with more personally relevant and valuable advertisements. The means of targeting and delivering advertising to potential customers have expanded tremendously in the last decade of so. Formerly, an individual was inundated with reams of “junk mail” of doubtful interest and usefulness. This onslaught of paper continues today but it has been joined by a veritable tsunami of junk email (generally known as “spam”) as well as a plethora of pop-up windows and other unwanted online advertisements. Yet, not only has the technology for delivering advertising material improved, in theory the technology for targeting that material has also improved. Today every purchase by a consumer is tracked and analyzed. Every online search and purchase is noted and finds its way to a database. All this information is sold to the highest bidder and used to aim targeted advertisements at the consumer. Even some paper junk mail is also being “aimed” using prior purchase data. And yet the onslaught of junk mail and spam continues—nay expands. It may be that some of the targeted advertisements are an improvement over unsolicited junk; however, either the improvement is too minor to be noticed or else these “improved” advertisements are buried under an avalanche of junk. It seems likely that at least part of the problem is the targeting. If an individual has searched for information concerning vitamins or has purchased vitamins, that individual receives untold numbers of advertisements for vitamins and various dubious health related products. The targeting is all to the advantage of the advertisers and not to the advantage of the consumer. The present invention aims at evening the playing field so that a consumer receives only advertisements likely to be of interest. This is not an anti-advertiser system because if a consumer receives only advertisements that are of interest, the consumer is far more likely to purchase the advertised products—greatly to the advantage of the advertiser. The inventive system provides a mechanism for targeting advertising based upon a user's trust network ratings/recommendations of the advertised content. Thus, the system provides greater advertisement value to both advertisers and advertisement viewers, since advertised content comes “recommended” to a viewer by the members of the viewer's personal trust network.

This inventive system differs in several important ways from known current efforts to advertise online. The method of the invention is practical and fairly simple in concept for users to understand. The invention allows users to control how or whether they trust the ratings of other users and thus, directly or indirectly, whether or not they will receive advertisements for recommended content from their trusted user network. In situations where advertising is email based, once the inventive system is in place, it is simple to install spam filters that block all other advertising so that the user will receive only interesting valuable information without all the junk.

There have bee major efforts in this area of the art including the following: 1) trust computation systems which envision and seek to build an automated inferential trust language and mechanism for filtering relevant information and inferring truthfulness and trustworthiness of information and information sources; 2) online social network (Friend of a Friend) systems like Friendster, LinkedIn, Yahoo's “Web of Trust”, Yahoo's “360”, etc. which attempt to allow members to leverage social networks for meeting others or gathering information and recommendations; and 3) efforts to make intelligent rating systems which leverage trust networks (an example would be the current FilmTrust experimental site). We believe that these efforts fall short in several ways and that this present invention will enhance and improve the value of online advertising for advertisers and viewers by leveraging viewers' trust network information within online trust network based information sharing systems.

The inventive system leverages information from online social/trust networks which facilitate the useful sharing of information. We believe that end-users will remain the best determiners of useful and personally relevant information and that technology best affords more powerful techniques and tools for gathering and sharing information that users want for making their decisions or learning about new products and services. Our system is a practical and helpful system that gives advertisers and viewers a more valuable mechanism for delivering and receiving advertisements. We believe that our invention will enhance and improve the value and safety of online recommendation systems. This system will make advertising efforts more effective in reaching interested viewers while also potentially saving viewers from time-wasting, personally non-valuable advertisements.

### SUMMARY OF THE INVENTION

With today's electronic information and media, filtering of information becomes an important function for preserving safety, time, and quality of life. Trust networks can be leveraged to allow people to filter information in ways that raise the quality of information and improve the quality of life. By applying this capability to advertising, our invention helps both advertisers and viewers more directly meet their needs, while potentially helping advertisers and viewers avoid the expense and waste of unwanted advertising.

The Internet needs personally relevant context to mitigate risks, offer good choices and information, and be optimally useful for individuals—we believe that our invention is one method for providing such usefulness. We also believe that as people become more sophisticated users of online services and advertising media, they will increasingly demand the type of ratings and information control provided by our invention.

The inventive system helps target advertising to viewers most likely to use the advertised item or service based upon their trust network recommendations. It also effectively puts more control into the hands of consumers because they control their own trust networks.

This system can provide viewers with advertising for items and services they find more valuable. For example, instead of a non-drinker being delivered beer advertisements the non-drinker might get an advertisement and coupon for a book that their trust network recommends highly.

This system can help provide advertising for safer “trust network approved” products and services. It can help people avoid fraud, and inferior or unsafe products and services that they might be susceptible to without such filters. This system can be in integral part of ‘safe online environments’ such as those for children or persons of particular vulnerability to certain advertising risks. For example, recovering alcoholics might rely upon their trust network to filter out advertisements for alcoholic beverages, and children might have a trust network that would help them avoid inappropriate advertisements such as those for drinking alcohol or smoking.

An understanding of the following terms will make it easier to follow the details of the invention.

Contextual Trust. The present system facilitates discovery, creation, and use of contextually meaningful trust and ratings. Trusting a person for rating one thing (e.g., restaurants) does not necessarily mean the person is trusted for rating other things (e.g., therapists). Context can be of any type—e.g., size or type of transaction, item, or service being rated/advertised. Meaningful context may differ from one embodiment to another and may even vary from user to user within an embodiment. Meaningful context may be determined and controlled in any fashion and may be explicit or implicit.

Degrees of Separation. “Degree of Separation” is a term and concept arising from the “six degrees of [social] separation” network/psychology experiments conducted in the 1960's by Stanley Milgram (see, Journal of Abnormal and Social Psychology 67: 371-378) which concept today influences a thriving field of science and online social network systems. In the present system the relational concept is applied to trust networks as follows: If a user (U1) trusts another user (U2), then that user (U2) have ‘1 degree’ of separation of trust from the user (U1). If the user (U2) trusts another user (U3) whom the first user (U1) neither trusts nor distrusts then the user (U3) has ‘2 degrees’ of separation of trust from the first user (U1). This relational concept can be extended and leveraged through many degrees of separation of trust though there are often practical calculation limits to the usefulness of the model beyond a certain point.

Degrees of Trust Network Separation. Online trust networks often leverage the concept of ‘degrees of separation’ between users, and by doing so they greatly increase the power of trust networks and hence the power of trust network based filtering systems such as this one. Degrees of separation will typically be a filtering criterion within embodiments of the present inventive system.

Advertising Filters. In the present system advertisements are filtered, targeted, and/or weighted according to the effective rating of the advertisements' content, style or source by the viewer's trust network across any number of degrees of separation of trust.

According to the inventive system advertisements (and ratings) can be for goods or services, people or businesses, or any, even multiple, aspects of these. They can take the form of email, web pages, web page content, online webpage ‘banners,’ television commercials, voice and text messages and any other electronic or non-electronic medium or advertising/soliciting method.

The inventive system can be used separately or in conjunction with other systems. It can be used within a single online population or service or across multiple online populations or services. It can be integral to or separate from the population or service that it serves. The inventive system is not limited to the Internet but can be in any form online or offline, across any medium or combination of media, and it can even incorporate manual or non-automated systems or methods.

The system may filter advertisements entirely ‘on demand’ or it may pre-calculate and store advertisements or portions thereof for use when filtered advertisements are required. That is, it may be a ‘real-time’ or a ‘cached’ advertisement filtering/targeting system or a combination of both. The system encompasses ratings of any form (explicit or implicit), and the advertisements can be used for any purpose including automated as well as manual uses.

Filters used with the system need not be absolute (e.g., complete exclusion of an advertisement), rather they can be used to control the weighting of advertisements as well. For example, advertisements for two items of equal rating might be displayed in order of the Effective Trust Level for the ratings. Where the subject advertisements have differing ratings (both above a show/no-show threshold), the advertisement having the higher rating can be listed first.

Advertising filters/targeting can be applied singly or in any combination and may be weighted in a combined fashion. For example, an advertisement might be targeted to people whose trust networks not only rate the advertised item at or above a threshold, e.g., 7 (on a scale of 1 to 10), but which also rate a specific competitor's product poorly (e.g., below the threshold).

For purposes of clarity, there are many potential complexities of this system that are not described in this patent application. This invention encompasses the key concepts and methods described above and all the methods and solutions for implementing such a system and addressing many of its subtle complexities. Those of skill in the art will readily understand how to deal with such complexities on the basis of the explanations provided herein.

### DESCRIPTION OF THE FIGURES

FIG. 1 shows a sample form which might be used within a trust network to allow a system user to control whom they trust.

FIG. 2 shows a sample form which a user might use to rate a ‘restaurant’ on several criteria

FIG. 3 illustrates the concept of a Trust Path and Degrees of Trust Network Separation.

FIG. 4 illustrates one mechanism for calculating an Effective Trust Level for various users within a user's trust network.

FIG. 5 illustrates one possible method of displaying the Effective Rating for several restaurants.

FIG. 6 outlines the steps implementing one embodiment of a trust network advertising system.

FIG. 7 is a diagram illustrating typical components in one implementation of the inventive system from an application component perspective.

FIG. 8 is a diagram of typical components in an alternate embodiment of the system from an application component perspective.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a method to provide advertising content according to a trust network.

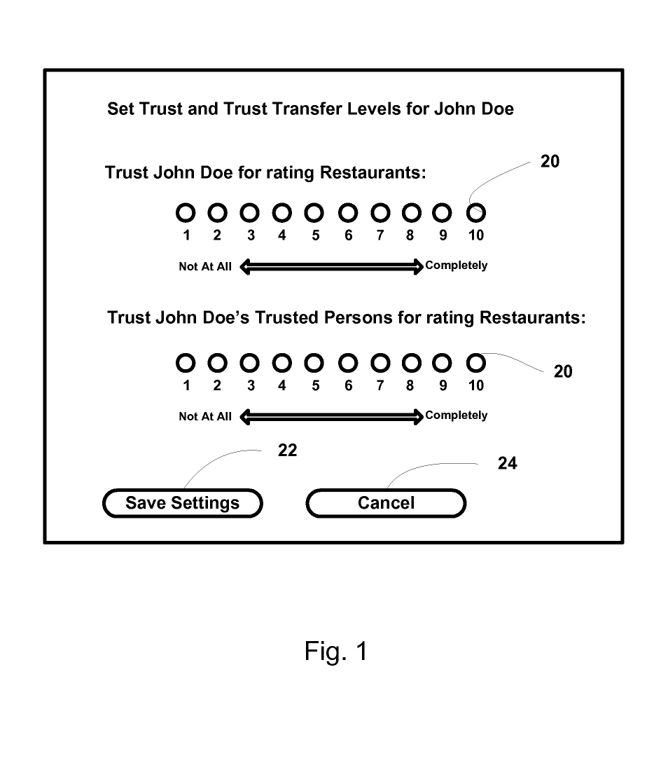

The present invention contemplates a user inputting information that describes the trust network that user wishes used to filter advertising. FIG. 1 shows a sample web-based form which could be used within a trust network to allow a system user to control who they trust. In some implementations of the invention this “trust relationship” may require the trustee's approval. In the figure the user is asked to set trust levels related to the ratings provided by a first rater, John Doe. The user is asked to specify to what degree the user trusts the restaurant ratings provided by the rater by selecting the most appropriate one of series of radio buttons 20. Next the user is asked to what degree restaurant rating from persons trusted by the first rater are to be trusted. Again, the choice is made by selecting one of the radio buttons 20. Finally, the user selects the appropriate button to either save (button 22) or cancel (button 24) the operation. If button 22 is selected, the user's profile is updated to include the information about the first rater.

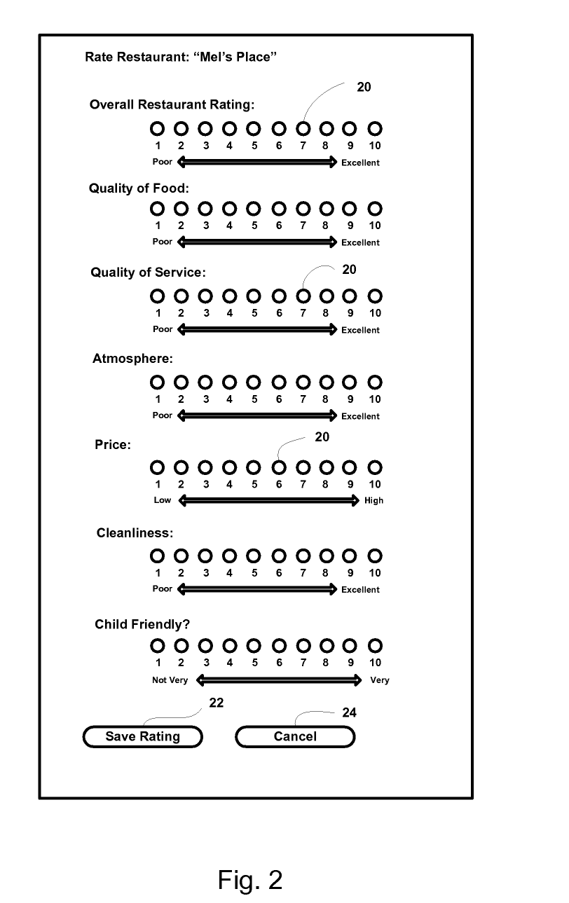

FIG. 2 shows a sample web-based form which a user might use to rate a given restaurant, ‘Mel's Place’ on several different criteria. Some embodiments might have ratings that are less detailed and others might have more detailed ratings. The inventive system is not necessarily restricted by the complexity of ratings. In the example the user selects the appropriate radio buttons 20 to describe the rating of several different aspects of Mel's Place. Finally the user selects button 22 or 24 to save or cancel, respectively, the operation.

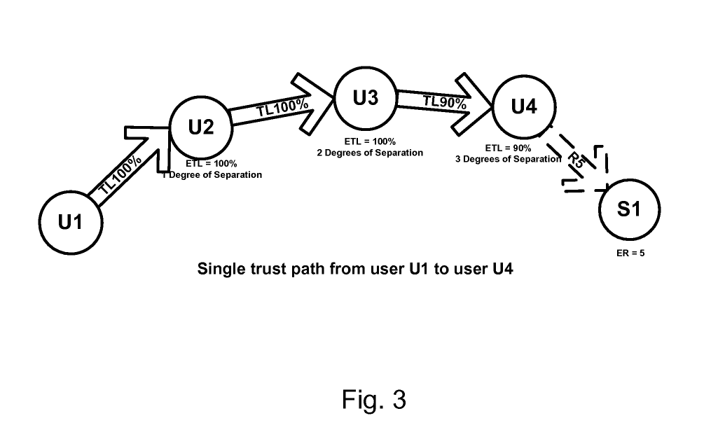

FIG. 3 illustrates the concept of a trust path (TP) and Degrees of Trust Network Separation. A single trust path (TP) is shown from user U1 to user U4 (who has rated seller a S1). U2 is immediately trusted by user U1 and is thus ‘1 Degree of Trust Network Separation’ from user U1. User U3 is immediately trusted by U2 (but not directly by U1) so that U1 is ‘2 Degrees of Trust Network Separation’ from U3. U4 is trusted by U3 (but not directly trusted by U2 or U1) and is hence ‘3 Degrees of Trust Network Separation’ from U1. Each leg of the path shows the Trust Level (TL) between one user and the next as a solid arrow. The Trust Level can range from 0 to 100%. In the figure ETL stands for Effective Trust Level which is calculated by multiplying together all the TLs between one user and another user. The final user U4 rates the seller S1 (dotted arrow indicates rating). The rating (R) ranges from 1-10 as illustrated in the earlier figures. Finally, an effective rating (ER) can be calculate for the entire trust path. The method used here is the sum of the products of the individual ETLs multiplied by R divided by the sum of all the ETLs (Formula 1). For purposes of clarity only one trust path is shown here, in most embodiments of this invention there will often be multiple and overlapping trust paths between users, and there are a number of methods for calculating and weighting trust paths and resulting relationships that will be obvious to those skilled in the art.

ER=Σ(ETL×R)/ΣETL Formula 1

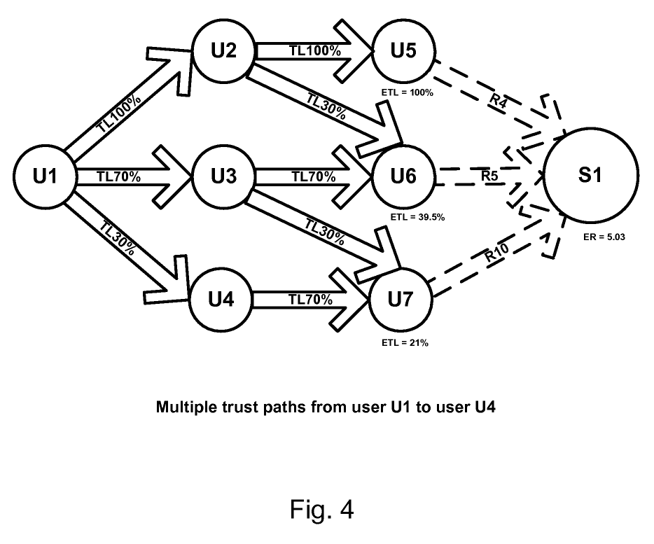

FIG. 4 is a diagram of one embodiment of a mechanism for calculating an Effective Trust Level for various users within a user's trust network. The conventions are the same as those used in FIG. 3 as is Formula 1. Here, however, only a single ETL is calculated for each trust path from a first user U1 to each of the most distant users, U5, U6 and U7. That is, the ETL for each distant user is the average of the ETLs for all trust paths to the user. For example, there are two trust paths from U1 to U6, namely U1 to U2 to U6 (ETL=30%, the product of the TL for U1 to U2 and the TL from U2 to U6)) and U1 to U3 to U6 (ETL=49%, the product of the TL for U1 to U3 and the TL from U3 to U6). The average of 30% and 49% is 39.5%. There are a number of other ways of normalizing and aggregating trust network and ratings information that can be accommodated by this inventive system. Effective Trust Level can be used as an advertisement filtering criterion in some embodiments. Some form of normalization and aggregation of ratings would be used by most embodiments of this inventive system to arrive at an Effective Rating (ER) for a given advertised item or service for a particular user. This and similar related methods can be applied to essentially any degree of trust network separation.

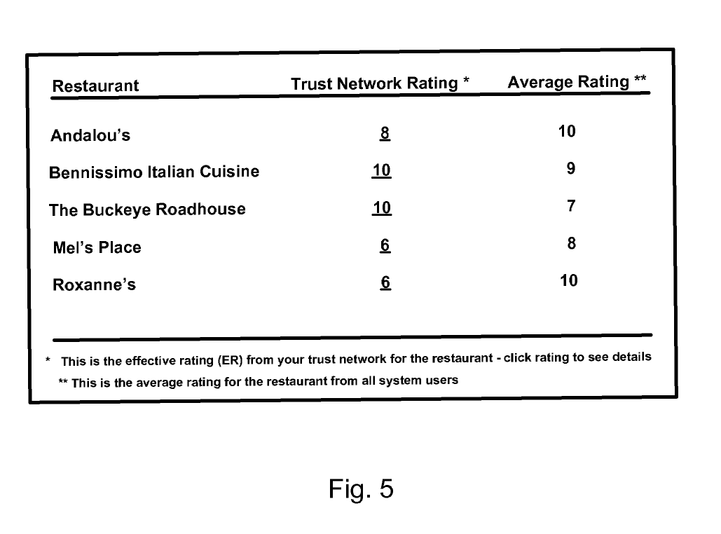

FIG. 5 shows one possible way of displaying the Effective Rating (ER) for a several restaurants. Here in an example website form where one can examine the Effective Trust Level (ETL) for a given rating (calculated according to FIG. 4) by clicking on the rating. The point to note is that depending on the network trust rating the ER for a given restaurant may depart significantly from the average rating for that restaurant. This is where the power of the invention comes in. If the advertisements from the restaurants are filtered according to ER and the threshold is set at 7, then the user would never receive advertisements from Mel's Place and Roxanne's, both of which were likely to be disappointing for this user. Furthermore, the user is immediately clued into Bennissimo's and The Buckeye Roadhouse, neither of which received the top scores according to the average ratings. There are a number of ways of displaying ETL and of calculating ETL, all of which are encompassed by this inventive system.

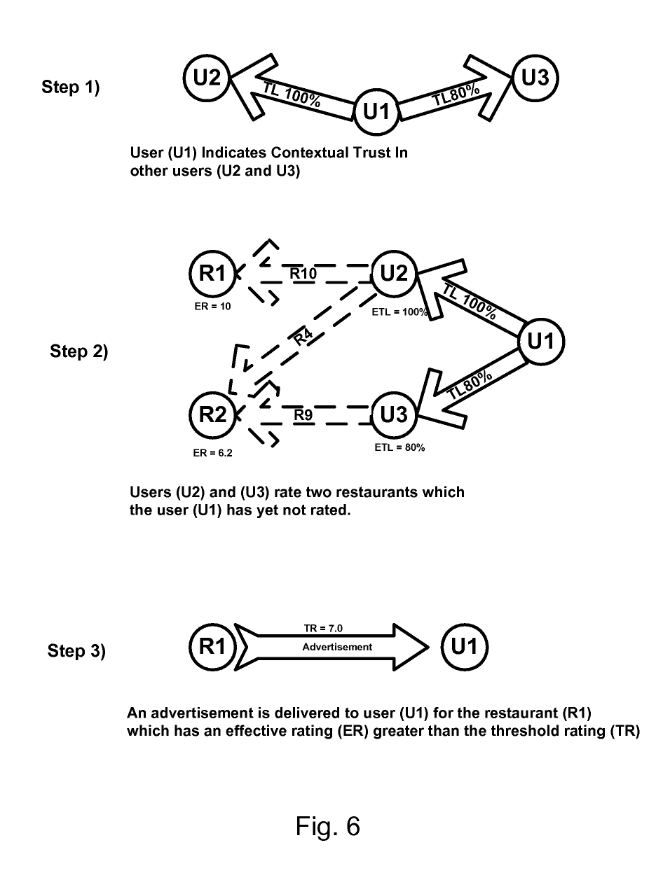

FIG. 6 outlines the steps involved in one embodiment of this trust network advertising system; the symbols and computations are the same as the earlier figure with the tailed arrow indicating delivery of an advertisement. In a first step a user U1 indicates his level of contextual trust for users U2 and U3. In a second step users U2 and U3 rate two restaurants R1 and R2 which user U1 has yet not rated (i.e., has not yet tried). It will be apparent to one of ordinary skill in the art that the order of the steps is not critical and that step 2 could occur temporally before step 1. In a third step advertisements for restaurants with an effective trust network rating for the user U1 are served to the user U1. In this example, the effective rating for one restaurant R2 is below the threshold effective rating value of 7, so the user U1 is not shown advertisements for that restaurant. For simplicity the advertisement in the third step is show as coming directly from the restaurant. In reality it would probably come from the servers of an online search engine or some other online service. Effective threshold ratings can be set in many ways in various embodiment of the system: by the users/advertisement viewers; by the system; and/or by the advertisers—the inventive system encompasses any method for determining or setting effective threshold ratings. The point is that the user will receive an advertisement from a restaurant he is not familiar with and yet is very likely to try and to appreciate. The user obtains great value by seeing only advertisements for places he is likely to approve of. The advertise obtains great value because its advertisements go to new customers who are likely to become repeat customers. Many other advertisement systems send advertisements to the wrong parties—consumers who are not at all interested or consumers who are already customers—rather like preaching to the choir.

While the inventive system is ideal for a dedicated online rating system where users are rewarded by receiving truly useful advertisements and advertisers are rewarded by having their advertisements sent to unusually suitable customers, it can also benefit a number of other online and “real world” scenarios. Presently there are a number of online search engines that sell search orders and leads according to a variety of different formulae. A main goal of these systems is to present an advertisement to a user in hopes that the presentation will result in a click through (that is a response by or a sale to that user). User leads may be sold according to the likelihood that the user will respond to the advertisement. Imagine the combination of the present invention with such a search engine. The user would be presented with advertisements with a high ER. This would be a super premium customer because of higher likelihood of positive response (this results in increased revenue for search engine as well as for the advertiser). The customer/user would also be happy because he or she would be more likely to receive advertisements of personal value. Once the ER information is available, it can also be used to select print advertisements (junk mail) sent to the user. There would be a savings in printing and mailing costs by not sending inappropriate advertisements (not to mention the savings in environmental costs). It is likely that advertisements sent under such a system will be “branded” (name, logo, etc.) so that the consumer recognizes the potential value of certain advertisements as compared to the regular mass of unread junk mail.

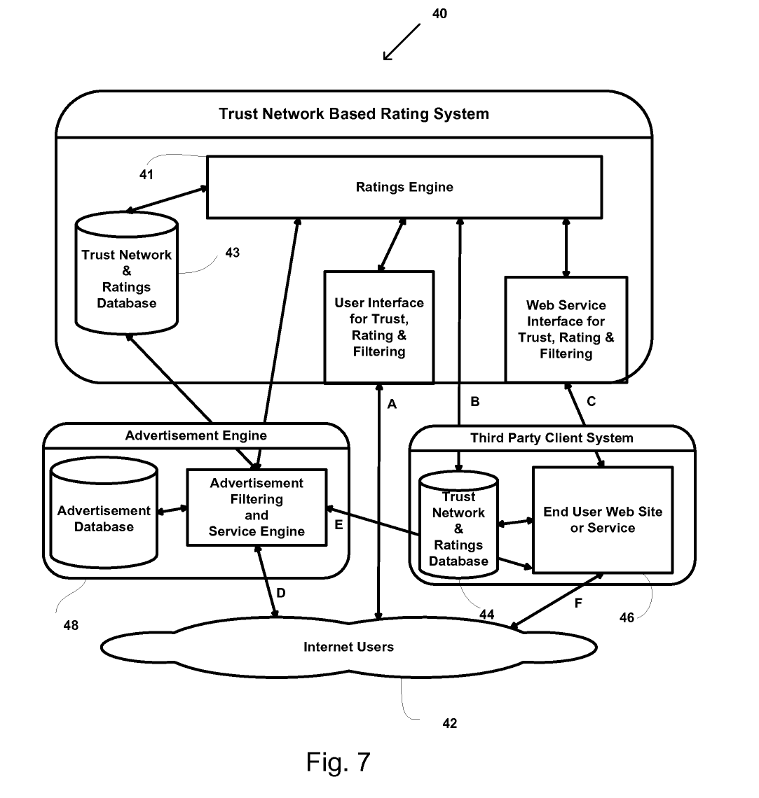

FIG. 7 is an illustration of typical components in one implementation of the inventive system from an application component perspective. Here user input for the “Trust Network Based Rating System” 40 can be gathered directly from Internet users 42 (consumer, buyers, seller, service provider, etc.) via interface A, from a third party client database 44 via interface B or through a third party website 46 via an API (application program interface), web service, or integrated functionality via interface C. The online services system gathers and stores users' ratings for restaurants and user's trust network information as shown in FIGS. 1 and 2. The Advertisement Engine 48 can use trust network and ratings data from the “Trust Network Based Rating System” 40 to determine if the user has already rated the advertised item or if the advertised item does or does not meet the rating threshold for the given user. The Advertisement Engine 48 serves advertised content that meets a certain rating criteria threshold (e.g. minimum Effective Rating) for the user. Advertisements could be served directly to the end users via interface D or to a website or web service 46 via interface E which would then serve the advertisement to the end user 42 via interface. The threshold criteria could be set in various embodiments by the advertisers, the viewers, or the system (via some administrative capacity). There are many possible architectural configurations to achieve filtering of advertisements based on trust network rating—all of which are encompassed by this inventive system. The system components are described using a sample embodiment with an online system where customers rate and discover restaurants.

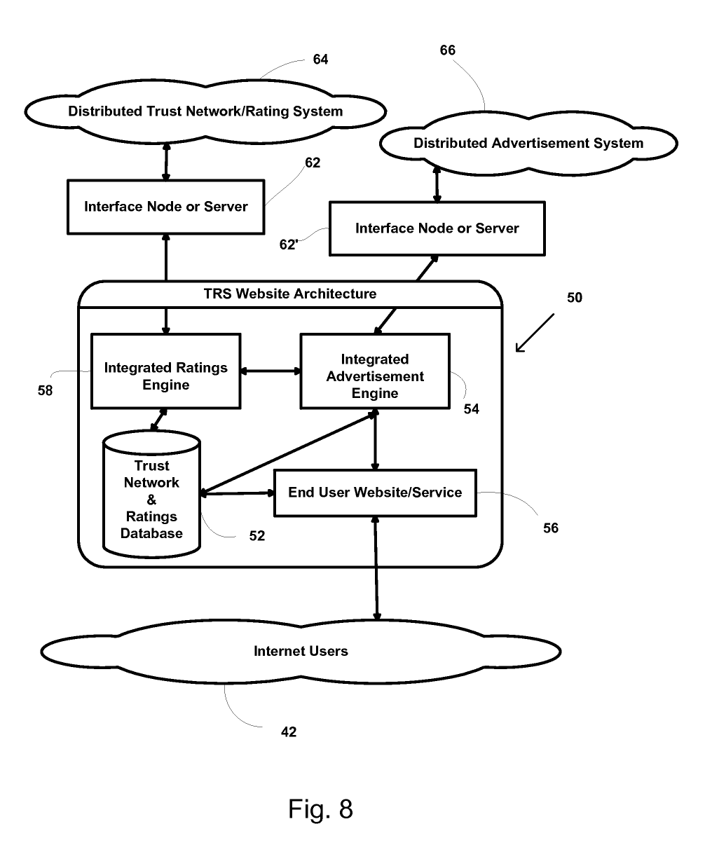

FIG. 8 is an Illustration of typical components in another embodiment of the system from an application component perspective. Here the Trust Website Architecture 50 obtains required user, trust, and ratings data directly from a database 52 that it shares with an end user website or web service 56 that leverages the system. The integrated Advertisement Engine 54 accesses the integrated Ratings Engine 58 and/or the database 52 to determine if advertisements should be served through the website to the given user 60. This could further comprise one independent ‘node’ of or server 62 for a larger ‘distributed network’ of independent systems which implement the distributed shared trust network or rating system 64, and/or the distributed Advertisement System 66. As will be apparent to one of ordinary skill in the art there are many different component architectures that are compatible with this inventive system and the present figure serves only as an illustrative example.

Mechanism/Method The interaction of components of this Advertising System can be seen in FIGS. 7 and 8. Essentially, the Advertisement Engine 48, 54 uses information from the Ratings Engine 41, 58 to determine which users are eligible to receive an advertisement. Typically these would be users that have not used the advertised service (restaurant), as determined from not having rated the service, yet whose trust network rates the advertised service (restaurant) highly. The Advertisement is then delivered to the appropriate users via email, a website, or any other means of advertising (including paper mail).

The user interface for gathering behavioral data, and displaying ratings information based upon the user's behavioral ratings filter may be integral to or separate from the e-commerce website application. Thus, the ratings system could be comprised of a separate system, software application, and/or hardware appliance which handle all of the behavioral information gathering and ratings filtering, or it could be comprised wholly or partially of pieces of software and hardware integral to the e-commerce (or other) system or online population which it serves.

FIG. 8 illustrates how a user would use the system according to certain embodiments. First, user rates an item/service/person (see FIGS. 4 and 5). Second, the user applies a ratings filter for ratings for another item from trusted raters who have rated (see FIG. 6). Third, the filtered ratings which are calculated by the Ratings Engine are used to determine which advertisements are sent to the user.

Alternative Embodiments of the Inventive System

The inventive system can be used separately or in combination with other advertising systems or methods. In one embodiment the inventive system might be particular to a specific trust network, whereas in other embodiments the inventive system might work with more than one trust network.

In some embodiments of the system, advertisements may be accompanied by ratings information for the viewer to see, whereas in others the advertisements may not be accompanied by ratings information for the viewer to see.

Certain embodiments of this system might not filter out advertisements, but rather weigh them based upon a viewer's trust network ratings.

Some embodiments of this system might give additional trust network based controls and filters of advertisement rating filters. For example, trust context and effective trust level and effective rating thresholds might be controllable by the users/advertisement viewers of this inventive system. Also, this invention can be used in conjunction with any other type of advertisement filtering system that is not trust-network based, including viewer controlled advertising systems.

In some embodiments of this system advertisements may be filtered or weighted based upon a viewer's trust network ratings of the advertising source rather than content. For example, if a viewer's trust network rates advertisements from a certain source highly (e.g. Zagat's Restaurant Guide, or from National Public Media), advertisements from that source might be delivered or in some fashion prioritized over other advertisements.

There are many ways in which these trust network based advertisement filters/weighting mechanisms can be controlled and there are embodiments of this invention for each of them singly or in any combination. These include: viewer controlled filters where viewers control which advertising they see based upon their trust network criteria that they set for themselves; system controlled filters in which the system service provider determines how advertisements are filtered using viewers' trust network information; and advertiser controlled mechanisms whereby advertisers determine how their advertisements are targeted to viewers with certain trust network criteria (e.g. a threshold rating for the advertised item).

In some embodiments advertisements might be stored for users to view when they decide as opposed to when the system decides. This inventive system can accommodate any mechanism or timing of advertisement delivery.

In one embodiment viewers can rate the advertisements themselves (not just the advertisement's subject matter or source) thus providing another type of advertisement rating upon which advertisements can be filtered within a trust network group.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. A method for automatically selecting advertisements appropriate for a user of a system wherein one or more computers execute a program comprising the steps of:
creating a social network comprising:
linking users directly to said network according to indication of association between users;
linking users indirectly to said network according to indication of association with directly linked users; and
linking users indirectly to said network according to indication of association with other indirectly linked users;
using said network to infer and calculate trust between linked users thereby inferring and calculating a Personal trust network for each user that is Personal to each user; and
delivering advertisements for items or services to users whose personal trust networks include users who have already provided the ratings or recommendations for the advertised items or services, so that the advertisements are more likely to be appropriate to the users receiving the advertisements.

2. The method according to claim 1, wherein identity of the users providing the recommendations or ratings for items or services is not revealed to the users receiving the advertisements, thereby allowing rating or recommendation sources to be anonymous.

3. (canceled)

4. (canceled)

5. The method according to claim 1, wherein the system is part of a website.

6. (canceled)

7. A method for controlling the delivery of advertising to users of a system wherein one or more computers execute a program comprising the steps of:
a first user indicating contextual trust in at least one other user which has indicated mutual contextual trust;
the at least one other user providing ratings for at least one item or service not yet rated by the first user;
computing effective ratings for said item or service based on the mutual contextual trust and the ratings of the at least one other user; and
delivering advertisements for said rated item or service to the first user wherein the step of delivering is controlled by filtering criteria which include the effective rating.

8. The method according to claim 7, wherein the first user determines the filtering criteria.

9. The method according to claim 7, wherein advertisers determine the filtering criteria.

10. The method according to claim 7, wherein the system determines the filtering criteria.

11. The method according to claim 10, wherein the system is part of a website.

12. The method according to claim 10, wherein the system a combination of a separate trust network based rating system and a separate advertisement engine.

13. (canceled)

14. (canceled)

15. (canceled)

16. (canceled)

17. (canceled)

18. (canceled)

19. The method according to claim 1, wherein a calculated personal trust network rating for the advertised item or service is delivered along with the advertisement.

20. The method according to claim 1, wherein a calculated personal trust network trust level for the users who have already provided the ratings or recommendations for the advertised items or services is delivered along with the advertisement.

21. The method according to claim 1, wherein the users receiving advertisements provide feedback to the system regarding the items or services being advertised.

22. The method according to claim 21, wherein the feedback provided by the users receiving advertisements is used to adjust the calculated personal trust network thereby adjusting and improving the users calculated personal trust networks and making them more accurate and valuable.

23. The method according to claim 21, wherein the feedback provided by the users receiving advertisements is used to adjust or filter future advertisements delivered to the users.

24. A computerized system for selecting advertisements to transmit to specific recipients wherein one or more computers execute a program comprising the steps of:
creating or using an explicit trust network comprising:
linking users directly according to indication of trust between users;
linking users indirectly according to common indication of trust with other users who are directly linked; and
linking users indirectly according to commonly shared indirect trust of linked users;
determining a personal trust network for each network user that is personal to each user by using the trust network to calculate trust between linked users thereby:
using implicit or explicit recommendations or ratings for items or services by the trust network users to deliver advertisements to other users whose personal trust networks include the users that have already provided the ratings or recommendations for items or services,
thereby providing advertisements to individual users for items or services that are recommended or rated by one or more members of their personal trust network.

25. The system according to claim 24, wherein the identity of the users providing the recommendations or ratings for items or services is not revealed to the users receiving the advertisements, thereby allowing the rating or recommendation sources to be anonymous.

26. The system according to claim 24, wherein a calculated personal trust network rating for the advertised item or service is also indicated along with the advertisement.

27. The system according to claim 24, wherein a calculated personal trust network trust level for the item or service raters is delivered along with the advertisement.

28. The system according to claim 24, wherein the users receiving advertisements provide feedback regarding the items or services being advertised.

29. The system according to claim 28, wherein the feedback provided by the users receiving advertisements is used to adjust their calculated personal trust network, thereby adjusting and improving the calculated personal trust networks and making them more accurate and valuable.

30. The system according to claim 28, wherein the feedback provided by the users receiving advertisements is used to adjust or filter future advertisements delivered to the user.
